(19) United States
(12) Patent Application Publication
(10) Pub. No.: US 2002/0113971 A1
(43) Pub. Date: Aug. 22, 2002

(54) Method for measuring characteristics, especially the temperature of a multi-layer material while the layers are being built up

(75) Inventors: Jorg-Thomas Zettler, Berlin (DE); Kolja Haberland, Berlin (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: LayTec Gesellschaft fur in-situ und nano-Sensork mbH, Berlin (DE)

(21) Appl. No.: 09/998,446

(22) Filed: Nov. 30, 2001

(30) Foreign Application Priority Data
Nov. 30, 2000 (DE) 100 61 168.0

(51) Int. Cl. G01B 9/02

(52) U.S. Cl. 356/450; 356/504; 356/519

(57) ABSTRACT

The invention relates to a method for measuring characteristics, especially the temperature of a multi-layer material during the build-up of the layers, especially of a stratified semiconductor system during epitaxy under constant process conditions.

Previously known methods using thermocouples or pyrometers are inaccurate. Others require an accurate knowledge of the optical properties of the material used.

According to the method, the material is illuminated with a constant illuminating energy, its reflectivity is measured as a function of time and the position of an extreme value of the Fabry-Perot oscillations of the respective layer is determined from this. From the position, the growth rate of the layer is determined. The process temperature and/or the composition of the layers is determined from previously ascertained comparison values.

The method can be employed in situ for the organometallic vapor phase epitaxy (MOVPE), molecular beam epitaxy (MBE) or similar methods and enables the sample temperature to be determined under standard growth conditions.

The invention relates to a method for measuring characteristics, especially the temperature of a multi-layer material while the layers are being built up, especially of a semi-conductor layer system during epitaxy under constant processing conditions. The method can be employed in situ for the organometallic vapor phase epitaxy (MOVPE), molecular beam epitaxy (MBE) or for similar methods and enables the sample temperatures to be determined under standard growth conditions.

An exact knowledge of the temperature is of extreme importance for the growth of semi-conductor layer systems and semi-conductor components, since practically all important growth parameters, such as the growth rate, composition and incorporation of doping materials are temperature dependent. Of course, these parameters can be determined at the end of the growth process. However, in order to have an influence on the growth process and to be able to transfer process conditions to other installations, an accurate knowledge of the temperature is indispensable.

The sample temperature depends essentially on external parameters (coating of the reactor walls, nature of the carrier gas, shape, size and rotational speed of the sample carrier, etc.). In practice, therefore, a calibration of the temperature- measuring device must be carried out frequently (the old calibration loses its validity when a parameter is changed). A conventional method uses special calibration samples, such as eutectics or melting samples for calibrating the temperature. This calibration can then take place only at a fixed temperature, which is specified by the melting point or the transition point of the material. A temperature comparison between different reactors, for example, for transferring processes from one installation to another, is therefore possible only at this one temperature. As a rule, the actual growth temperature is not at this transition temperature and the method has therefore only limited usefulness for adjusting the actual growth temperature and is therefore problematic. Furthermore, the calibration is very time consuming.

Essentially, two methods are known for measuring the temperature in an MBE or MOVPE installation:

1. Measurement with Thermocouples:

In the sample carrier (susceptor, usually made from graphite), on which the sample is lying, there is a thermocouple. The temperature, measured by the thermocouple, corresponds to the actual sample temperature only if the sample is in thermal equilibrium with the susceptor. Under actual conditions, this is not necessarily the case. Modem, commercial epitaxy systems usually have rotating samples. In the case of the MOVPE, the susceptor frequently comprises several parts. In the main susceptor, there is an additional disk, which is rotated and carried by flowing gas. Due to this construction, the thermal content between the heated susceptor (with the thermocouple) and the sample is greatly reduced. Additional effects, such as cooling by the flowing gas, changed radiation or the formation of a radiation equilibrium in the reactor by a coating of the inner walls, can lead to further deviations. The exact shape, size and coating of the susceptor and of the reactor have an effect on the magnitude of the deviation of the sample temperature from the thermocouple temperature.

In any case, only the temperature of the susceptor can be measured with thermocouples. The actual temperature of the sample can deviate from this, for example, because the radiation changes or a radiation equilibrium is formed in the reactor or the thermal contact is unsatisfactory.

2. Measurement with Pyrometers:

Large multi-wafer installations sometimes work with planetary rotation, that is, several sample carriers rotate on one disk about one axis and, in addition, about themselves. Since thermocouples cannot be used here, temperature is measured by means of pyrometry, the thermal emission of infrared light from the sample being detected. This method assumes that the emissivity of the material measured is known precisely in advance, in order to be able to determine the temperature without error from the measurement. In addition, pyrometry can be used only in a limited range of temperatures (above about 300° C.).

As already described above, melting point determinations or eutectic calibrations are used in order to calibrate the thermocouple temperature or pyrometer temperature to the true sample temperature. For this purpose, special substances with accurately known melting points or transition points are heated in the epitaxy system and the temperature difference is determined. This can be done only in a separate growth run, since special samples must be employed, which cannot be used for growth. In addition, not all conditions in the reactor correspond to real growth conditions.

Furthermore, it is known from U.S. Pat. No. 5,403,433 that reflection data can be used for determining temperatures. For this purpose, the position of the critical points of a semiconductor is measured in that the temperature-dependent shift of the fundamental band edge is determined. The latter can be determined by measuring the light scattered by the back of the samples, since the scattered light can be measured only if the sample is transparent to the wavelength of light used. It is a disadvantage that a transmission measurement is time-consuming and can hardly be carried out in situ. In addition, a very accurate knowledge of the optical properties of the material used (temperature dependence of the dielectric function or of the refractive index and of the absorption constant) is required.

It is an object of the invention to indicate a method of the type mentioned initially, which permits the temperature to be measured in situ with considerable less effort.

Pursuant to the invention, this objective is accomplished by the distinguishing features in the characterizing part of claim 1 in conjunction with the distinguishing features in the introductory portion. Appropriate developments of the invention are the object of the dependent claims.

According to this objective, the material is illuminated with a constant illumination energy, its reflectivity is measured over time and, from this, the position of an extreme value of the Fabry-Perot oscillations of the respective layer is determined, from which the growth rate of the layer and, by means of previously determined comparison values, the process temperature and/or the composition of the layers are/is determined. In the following description, it is assumed, for the sake of a simpler representation, that the first minimum, which can be evaluated most quickly and most easily, is used as extreme value. However, any other extreme value could have been utilized equally well.

It was found that, by measuring the reflectivity of a sample after determining the first minimum of the Fabry-Perot oscillation, direct conclusions can be reached concerning the temperature of the sample and concerning other characteristics, if the photon energy during the process, in which the measurement is to be made, is held constant.

Most of the epitaxy installations can be equipped with an optically transparent window, so that optical measurements can be carried out at a perpendicular incidence. The reflectivity of the sample can be measured by means of an optical method. More precisely, a measured quantity DC (voltage of a detector) is proportional to the reflectivity of a sample as well as to factors influencing the measurement arrangement:

DC=reflectivity×apparatus function.

The apparatus function can be eliminated by a suitable normalization of the signal measured, so that the reflectivity can be determined as such. Since the measured reference value need not be known as an absolute quantity, the measurement of the reflectivity, related to a starting material, is sufficient.

The method introduced is based on the measurement of a detector voltage DC at a fixed photon energy in the IR, visual or UV region of the spectrum and on the determination of a first minimum of the detector voltage (transient measurement) during the growth of a defined stack of layers.

In order to monitor the quality of the material during the growth of the stack of layers, RAS spectra (reflection anisotropy spectroscopy) can be measured before and after the growth. In addition, an RAS signal can also be measured during the growth parallel to the DC transient. Because of the high surface sensitivity of the RAS, a degradation of the layer can be indicated in good time in this manner.

If the temperature dependence of the dielectric function is used for the method described above in connection with the state of the art, in that, knowing the temperature dependence of the refractive index, the temperature is derived from the measured refractive index, it is always necessary to evaluate a database, in which the value of the refractive index for the material used is linked with the temperature. With that, any inaccuracy in the database goes over fully into the temperature measurement. In order to be able to determine the refractive index at all from the measured curve, a simulation (calculation) of the measurement with fit is necessary in every case.

On the other hand, according to the present method, directly measured crude data, namely the reflectivity value of the first minimum of the Fabry-Perot oscillations, is used for the comparison of temperatures and for the calibration. With that, a database does not enter into the relative comparison of temperatures, for example, between different installations, and a calculation or simulation is not required. Of course, by an additional database fit, the accuracy of the measurement can be increased further. Only when the measured reflectivity value of the minimum is to be assigned to an absolute temperature, is a calibration curve necessary for reading off the temperature value. However, a database for the refractive index is not required here.

The invention will be described in greater detail below by means of an example. In the associated drawings

FIG. 1 shows a known arrangement for the combined reflection and RAS measurement of a sample,

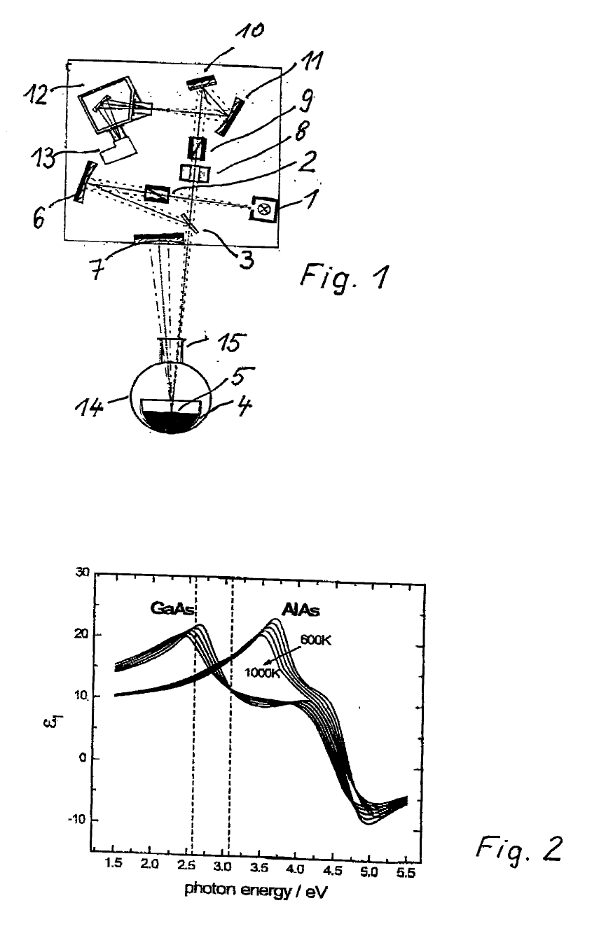

FIG. 2 shows the temperature dependence of the real portion of the dielectric function for GaAs and AlAs,

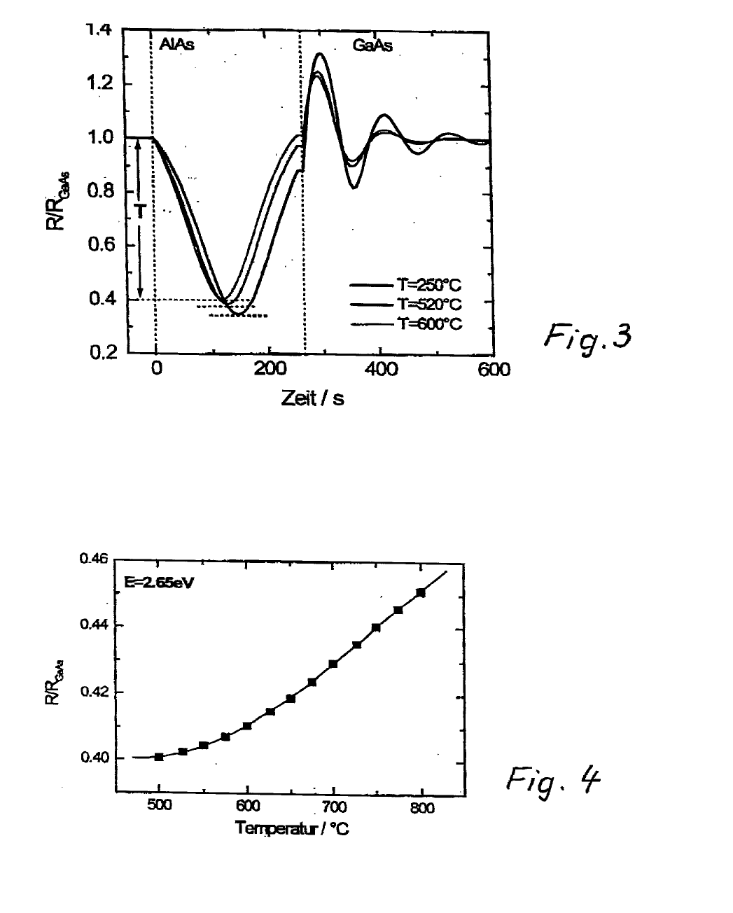

FIG. 3 shows the relationship between the Fabry-Perot oscillations and the temperature,

FIG. 4 shows a calibration curve for the reflectivity as a function of the temperature, calculated from database spectra,

FIG. 5 shows a measured calibration curve for the reflectivity as a function of the temperature,

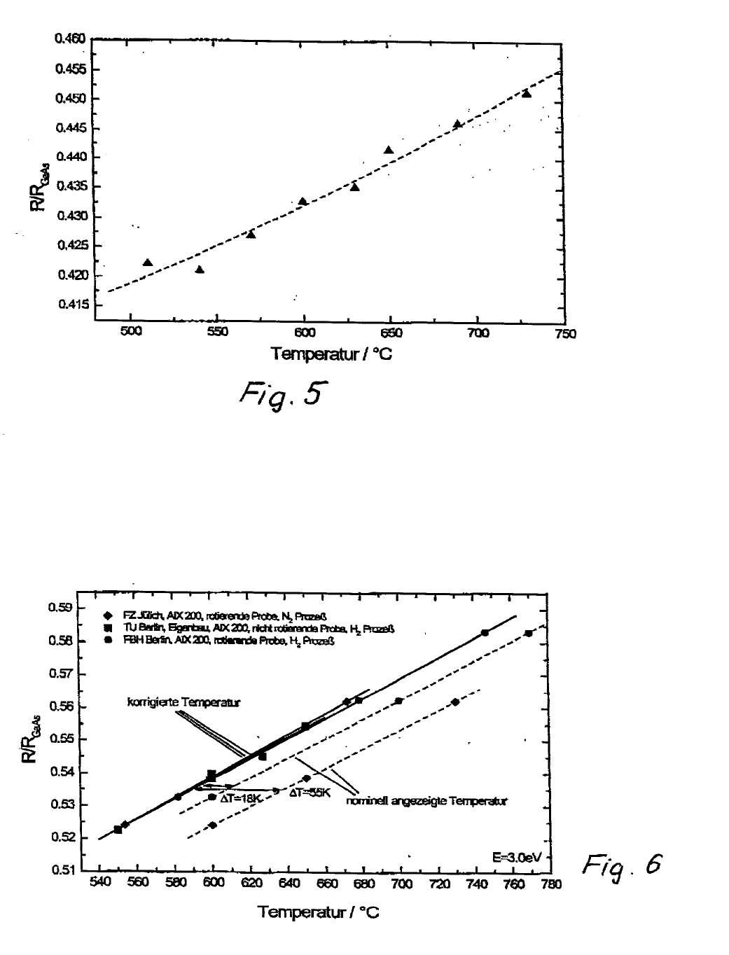

FIG. 6 shows the application of the method for calibrating MOVPE reactors,

FIG. 7 shows the relationship between the Fabry-Perot oscillations and the growth rate during epitaxy by means of a model calculation,

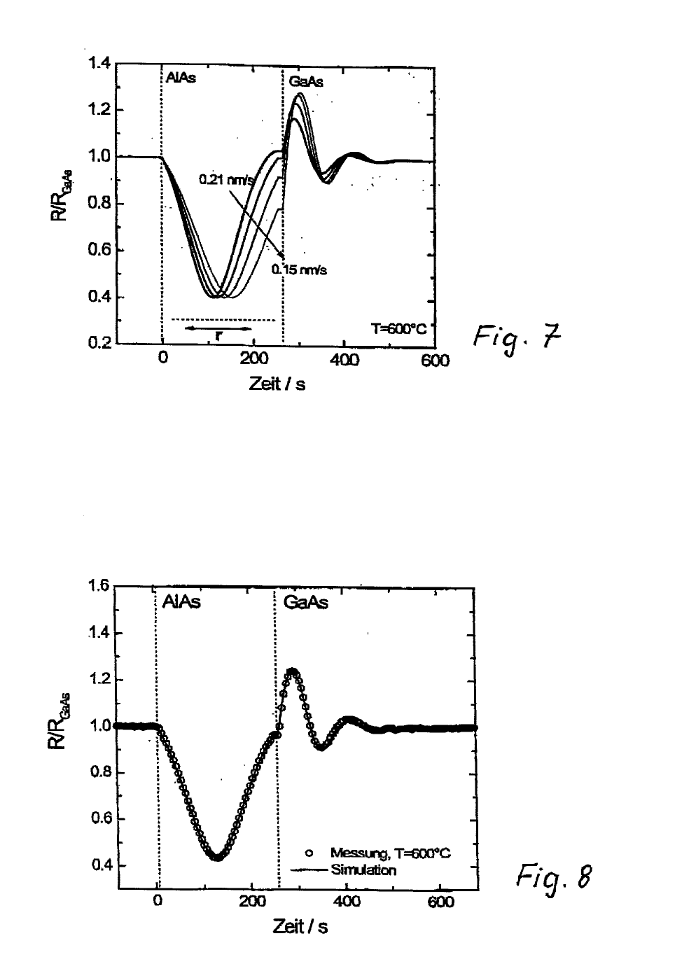

FIG. 8 shows the measured course of the reflectivity at a certain temperature, fitted with database values,

FIG. 9 shows the reflectivity transient during the growth of a ternary material,

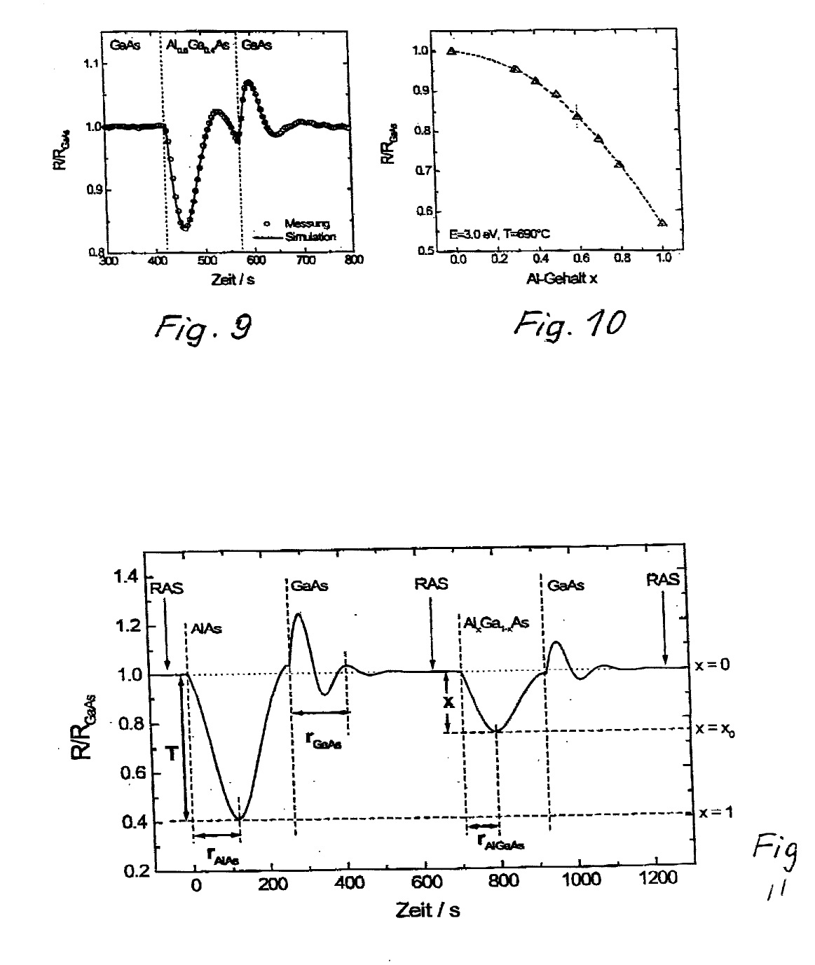

FIG. 10 shows the resulting calibration curve for the aluminum content of the ternary material and

FIG. 11 shows the reflectivity transient during the epitaxy of a 5-layer stack.

FIG. 1 shows an arrangement for the combined measurement of reflection and RAS in a sample in an MOVPE installation. The light of a xenon lamp 1 is focused through a polarization prism 2 and a beam divider 3 onto a rotating sample holder 4 with a sample 5. A first mirror 6 focuses the light on the sample 5. The light is reflected by the sample 5 onto a spherical mirror 7. The spherical mirror 7 has a compensating function with respect to the wobbling motion, which the rotating sample carrier 4 is carrying out. The light is then passed back to the beam divider 3. By means of a photo-elastic modulator 8, the light can be modulated and retrieved over a further polarization prism 9. The light is focused on a monochromator 12 by a further mirror 10, 11 and detected by means of a silicon diode detector 13.

The sample carrier 4 is in an MOVPE reactor 14, the light reaching the sample 5 through an optical window 15.

The buffer (material A), measured at the start and also at the end by means of the detector voltage DC, permits the measured transient to be normalized. This leads to the elimination of the apparatus function:

DC/DC_{material A}=R/R_{material A}

The apparatus function contains all portions of the measurement signal, which depend only on the optical system used and not on the sample, such as the intensity distribution of the xenon lamp 1, the spectral sensitivity of the detector 13, etc.

The reflectivity of the sample 5 depends on the optical properties (dielectric function ε₁, ε₂ or the refractive index n and absorption k), which are temperature dependent. Because of refractive index difference and the resulting multi-beam interference at the sample surface, the known Fabry-Perot oscillations are observed during the growth.

It has now been found that the depth of the first minimum of the Fabry-Perot oscillations during the growth of material B can be used directly as a measure of the temperature, if the reflectivity is measured at a suitable constant photon energy. The depth of this minimum depends only on the temperature and not on other parameters, such as the growth rate. Depending on the growth rate aimed for, the minimum is reached within a few seconds or minutes during the growth process.

In order to measure the temperature dependence of the dielectric function in this simple manner, it is necessary to select a suitable photon energy. As an example, FIG. 2 shows the temperature dependence of the real portion of the dielectric function for GaAs and AlAs. Advisably, an energetic position, at which the temperature sensitivity of one material is large, while that of the other material is small, is used for the method. In addition, at this energy, there should be a monotonic region and no critical point in the temperature range under consideration. The critical points for GaAs and AlAs are far apart. An energy range can therefore be found, in which these requirements are fulfilled well: E=2.6 . . . 3.1 eV (region indicated by broken lines). In this region, R=R(ε₁) (since AlAs practically does not absorb) and ε₁(AlAs)=constant. Accordingly, the temperature dependence of GaAs can be measured directly over ε₁(GaAs) as ε₁(T).

FIG. 3 shows the dependence of the first minimum of the Fabry-Perot oscillations on temperature by means of a stack of layers, the following material system being selected for the method:

Material A (substrate)=gallium arsenide (GaAs)

Material B (first layer)=aluminum arsenide (AlAs)=50 nm

Material A (second layer) =gallium arsenide (GaAs)=200 nm

The position of the minimum is shifted, the depth of the minimum also being changed. The representation shows that the value of the reflection parameter R_{GaAs} at the minimum can be used as a measure of the actual temperature.

Since the measured relative value of the reflection parameter R_{layer}/R_{GaAs} at the minimum is a measure of the temperature, this parameter can be used immediately for relative comparisons between different growth installations, without having to know the absolute values of the reflectivity. For measuring an absolute temperature, either an accurate database of the dielectric functions of the two materials A and B used must be available (such a database can be set up by in situ measurements with spectroscopic ellipsometry or with reflection measurements, as introduced here) or a calibration point must be produced by means of a eutectic calibration. The calibration curve, so obtained, is then universally valid for each epitaxy installation.

In FIG. 4, such a calibration curve, calculated from database spectra, has been plotted.

In FIG. 5, a calibration curve, which is also for a phototon energy of E=2.65 eV and has resulted from measurements of the minima at different temperatures, is shown. The temperature range, of interest for the III-V epitaxy, is shown.

With such a calibration curve, it is then possible to calibrate other temperature measuring devices present, which are described above.

FIG. 6 shows such a calibration of different installations. The measured values for three different MOVPE installations with rotating and not rotating samples are plotted. The sample temperatures were measured with thermocouples. The nominal temperatures of the rotating samples (broken straight lines), indicated by the thermocouples, differ clearly from one another and from those of the not rotating samples. The measurement of the not rotating samples shows the true temperature sufficiently accurately. From the requirement that the curves should all be congruent, the temperature deviation for each reactor can be determined.

FIG. 7 shows the shift of the first minimum of the Fabry-Perot oscillations at a constant temperature and at different growth rates. It can be seen that the minima are equally deep, but are shifted along the time axis as the growth rate drops. Under otherwise constant conditions, the growth rate of the layers can also be determined from the transients measured.

For this purpose, transients for several growth rates were determined. One of these is shown in FIG. 8. For a more precise evaluation of the measured reflection transients, the course of the curve can be simulated by means of databases and the corresponding parameters (refractive index n, absorption k, growth rates r₁, r₂ can be fitted. This permits either the depth of the minimum, uncoupled from the noise of the individual measurement points in the minimum, to be determined very accurately or, alternatively, the setting up or improving of a database at a known temperature for these values, which can be used as such later on for a comparison with measured curves.

By expanding the stack of layers by two additional layers, the temperature as well as the composition of a ternary material and the associated growth rate can be measured with the method in the same run. The stack of layers is then selected, for example, as follows: material A—approximately 50 nm material B—approximately 200 nm material a—approximately 50 nm ternary material C—approximately 200 nm material A.

As explained above, the temperature as well as the growth rates of materials A and B are determined from the first three layers. Since the temperature is now known, it is possible, from the last two layers, to separate the composition dependence of the dielectric function of material C from the temperature dependence, if a calibration curve for the composition of the ternary material C is prepared first. With that, the depth of the first minimum of the Fabry-Perot oscillations of the ternary material C can be used directly as a measure of the composition of material C. The refractive index and, with that, the dielectric function are changed by the composition in the same way as by the temperature. The two effects can be separated cleanly by the skillful selection of the stack of layers and the two-step measuring process.

FIGS. 9 to 11 show the use of this method for AlₓGa₁₋ₓAs. The transient for the ternary material C, AlₓGa₁₋ₓAs, is measured according to FIG. 9. As shown by FIG. 10, a calibration curve as a function of the aluminum content can be prepared from the minima of the first Fabry-Perot oscillation. FIG. 11 shows a simulation of a complete measurement for the determination of the growth rate (r), the temperature (T) and the aluminum content (x) in one run.

The uncoupling of the effects, which are caused by the change in the growth rate from those, which are caused by a temperature change, is a special advantage of the method. Only by the skilled selection of the stack of layers and the measurement at a suitable photon energy can the growth rate and the temperature be determined unambiguously from a transient. With that, a comparison of temperatures between different growth installations is also possible.

The measurement can be regarded as reliable especially when the value of the reflectivity is equally large before and after the growth of an A-B-A stack of layers. This is the reason why a layer A is advisably grown before and after the layer B in the stratified structure.

Degradation of the layers could result in the measurement of defective temperature information. However, a simultaneously measured RAS signal functions as an early warning system, since degradations are seen distinctly earlier in the RAS signal than in the reflectivity of the sample.

The temperature range, in which the method can be employed, is practically unlimited, as long as suitable photon energy is employed and epitaxial growth is possible for the material used.

It is necessary to ensure that the measurements are always carried out at exactly the same photon energy. If a xenon high-pressure lamp is used as a light source for the reflectometer, the position of the emission line at E=2.65 eV can be used. The spectral position of the line is practically independent of external parameters and can therefore be headed for accurately independently of the sample.

The accuracy of the method depends essentially on the signal-to-noise ratio of the spectrometer used for the reflection measurement. For the example shown, the signal-to-noise ratio of the optical system permits an accuracy of measurement of ±5° K.

Before any epitaxy run, the method can be used to calibrate the temperature of a thermocouple or a pyrometer precisely in less than one hour. The achievable accuracy of the temperature measurement for comparable measurements is at least of ±5° K. With that, calibration of the reactor temperature for the actually present susceptor/reactor configuration is possible.

In the case of horizontal, one-wafer reactors, the true sample temperature also depends on the state of coverage of the liner tube (temperature difference of at least 10° K), while the thermocouple indicates a constant temperature. This temperature difference, which otherwise cannot be measured, can be measured with the method introduced.

### LIST OF REFERENCE SYMBOLS

| | |
|---|---|
| 1 | xenon lamp |
| 2 | polarization prism |
| 3 | beam divider |
| 4 | sample holder |
| 5 | sample |
| 6 | mirror |
| 7 | spherical mirror |
| 8 | modulator |
| 9 | polarization prism |
| 10 | mirror |
| 11 | mirror |
| 12 | monochromator |
| 13 | silicon diode detector |
| 14 | MOVPE reactor |
| 15 | optical window |
| T | temperature |
| r | growth rate |
| x | aluminum content |

1. A method for measuring characteristics, especially the temperature of a multi-layer material while the layers are being built up, especially of a semi-conductor layer system during epitaxy under constant processing conditions, wherein the material is illuminated with a illuminating energy, its reflectivity is measured over time and, from this, the position of an extreme value of the Fabry-Perot oscillations of the respective layer is determined, from which the growth rate of the layer and, by means of previously prepared comparison values, the process temperature and/or the composition of the layers are/is determined.

2. The method of claim 1, wherein the extreme value of the first minimum of the Fabry-Perot oscillations is utilized.

3. The method of claims 1 or 2, wherein the actually measured reflectivity is related to the reflectivity of a reference material, on which at least one layer is built up.

4. The method of one of the preceding claims, wherein, at the end of a process step or of the whole process, a layer of the same material as a substrate material, on which at least one layer is built up, is washed and its characteristics are compared with the characteristics present at the start of the process.

5. The method of one of the preceding claims, wherein the material properties are monitored at the same time, at least, however, before the start and after the end of the process by an RAS measurement.

6. The method of one of the preceding claims, wherein the reflectivity at the extreme value of the Fabry-Perot oscillations under consideration is used to determine the process temperature.

7. The method of one of the preceding claims, wherein the process time up to the extreme value of the Fabry-Perot oscillations under consideration is used to determine the growth rate of the layers.

8. The method of one of the preceding claims, wherein, when the process temperature is determined previously, the reflectivity of the extreme value of the Fabry-Perot oscillations of a ternary layer under consideration is used to determine the composition of the layer.

9. The method of one of the preceding claims, wherein the illumination energy is selected in a range, in which the temperature dependence of the real portion of the dielectric function of the participating materials is monotonic.
